(19) United States
(12) Patent Application Publication
(10) Pub. No.: US 2023/0319925 A1
(43) Pub. Date: Oct. 5, 2023

(54) METHOD AND SYSTEM FOR WLAN MULTI-LINK MANAGEMENT FRAME ADDRESSING

(71) Applicant: HUAWEI TECHNOLOGIES CO., LTD., Shenzhen (CN)

(72) Inventors: Michael MONTEMURRO, Kanata (CA); Stephen MCCANN, Kanata (CA); Guogang HUANG, Shenzhen (CN)

(73) Assignee: HUAWEI TECHNOLOGIES CO., LTD., Shenzhen (CN)

(21) Appl. No.: 18/206,462

(22) Filed: Jun. 6, 2023

Related U.S. Application Data
(63) Continuation of application No. PCT/CN2021/080339, filed on Mar. 12, 2021.

(51) Int. Cl. H04W 76/15; H04W 60/04; H04W 12/037

(52) U.S. Cl. CPC H04W 76/15; H04W 60/04; H04W 12/037; H04W 84/12

(57) ABSTRACT

An aspect of the disclosure provides a method of communication between a first multi-link device (MLD) and a second MLD, the first MLD being affiliated with a first station (STA) and a third STA, the second MLD being affiliated with a second STA and a fourth STA. Such a method includes receiving, by the first multi-link device (MLD) from the first station (STA), a management frame comprising a header indicating address information associated with the second MLD. Such a method further includes encrypting, by the first MLD, the management frame based on a security association established between the first MLD and the second MLD. Such a method further includes sending, by the first MLD, the encrypted management frame toward the second MLD via one of the first STA and the third STA.

### CROSS-REFERENCE TO RELATED APPLICATIONS

This is the first application filed for the present invention.

### FIELD OF THE INVENTION

The present invention pertains to the field of communication networks, and in particular to systems and methods for WLAN multi-link management frame addressing.

### BACKGROUND

In IEEE 802.11, unicast management frames are encrypted based on the established security association. For multi-link operations (MLO), security association is established between an access point (AP) multi-link device (MLD) and a non-AP MLD. Accordingly, there is no security association between the AP MLD's affiliated APs and the non-AP MLD's affiliated stations (STAs). Accordingly, handling of the unicast management frames, for example, radio specific management frames, at the affiliated APs and the affiliated STAs may be limited due to the nature of the security association between the AP MLD and the non-AP MLD.

Therefore, there is a need for a system and methods for WLAN multi-link management frame addressing that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An aspect of the disclosure provides a method of communication between a first multi-link device (MLD) and a second MLD, the first MLD being affiliated with a first station (STA) and a third STA, the second MLD being affiliated with a second STA and a fourth STA. Such a method includes receiving, by the first multi-link device (MLD) from the first station (STA), a management frame comprising a header indicating address information associated with the second MLD. Such a method further includes encrypting, by the first MLD, the management frame based on a security association established between the first MLD and the second MLD. Such a method further includes sending, by the first MLD, the encrypted management frame toward the second MLD via one of the first STA and the third STA.

Such a solution allows secure communication between MLDs via their affiliated STA's, using security associations between the MLDs, without the need to establish separate security associations between each affiliated STA.

In some embodiments, the header of the management frame indicates one of: a destination address of the second station and a source address of the first station. In some embodiments, the header of management frame further indicates a receiver address of the second STA and a transmitter address of the first STA.

In some embodiments, such a method further includes updating, by the first MLD, a header of the encrypted management frame to indicate one or more of: a receiver address of the second MLD and a transmitter address of the first MLD.

In some embodiments, the first MLD has a medium access control (MAC) instance of the first MLD.

In some embodiments, the first STA has a station management entity (SME) instance of the first STA. In some embodiments, the third STA has a MAC instance of the third STA.

In some embodiments, the first STA includes a first internal connection to the first MLD, the third STA includes a third internal connection to the first MLD, and wherein the receiving step comprises receiving via the first internal connection; and
the sending step comprises transmitting the encrypted management frame using an over the air (OTA) connection.

In some embodiments, the sending step includes sending the encrypted management frame to the first STA via the first internal connection; and sending the encrypted management frame from the first STA to the second STA via the OTA connection, wherein the header of the encrypted management is updated to indicate a receiver address of the second STA and a transmitter address of the first STA.

In some embodiments, the sending step includes sending the encrypted management frame to the third STA via the third internal connection; and sending the encrypted management frame from the third STA to the fourth STA via the OTA connection, wherein the header of the encrypted management frame is updated to indicate a receiver address of the fourth STA and a transmitter address of the third STA.

Another aspect of the disclosure provides a method of communication between a first multi-link device (MLD) and a second MLD, the first MLD being affiliated with a first station (STA) and a third STA, the second MLD being affiliated with a second STA and a fourth STA. Such a method includes receiving, by the first multi-link device (MLD) from a second MLD using an over the air (OTA) connection, an encrypted management frame comprising a header indicating address information associated with the second MLD. Such a method also includes decrypting, by the first MLD, the encrypted management frame based on a security associated established between the first MLD and the second MLD; and sending, by the first MLD, the decrypted management frame based on a header of the decrypted management frame.

In some embodiments, the header of the encrypted management frame indicates one of: a destination address of the first STA and a source address of the second STA.

In some embodiments, wherein the header of the encrypted management frame further indicates a receiver address of the first MLD and a transmitter address of the second MLD.

In some embodiments, the OTA connection is between the first STA and the second STA, and wherein the first STA includes a first internal connection to the first MLD, and wherein the receiving step includes receiving the encrypted management frame via the OTA connection; and sending the encrypted management frame from the first STA to the first MLD via the first internal connection.

In some embodiments, the OTA connection is between the third STA and the fourth STA, and wherein the third STA includes a third internal connection to the first MLD, and wherein the receiving step includes receiving the encrypted management frame via the OTA connection; and sending the encrypted management frame from the third STA to the first MLD via the third internal connection.

In some embodiments, the method further includes updating, by the first MLD, the header of the decrypted management frame to indicate one or more of: a receiver address of the first STA, a transmitter address of the third STA.

In some embodiments, the sending, by the first MLD, the decrypted management frame based on a header of the decrypted management frame includes sending, by the first MLD to the first STA, the decrypted management frame.

In some embodiments, the first MLD is a MAC instance of the first MLD.

In some embodiments, the first STA is a station management entity (SME) of the first STA.

In some embodiments, the second STA has a MAC instance of the second STA.

In some embodiments, the first STA is the same as or different from the second STA. In some embodiments, the first MLD is one of an access point (AP) MLD or a non-AP MLD.

Another aspect of the disclosure provides a system of communication between a first multi-link device (MLD) and a second MLD, the first MLD being affiliated with a first station (STA) and a third STA, the second MLD being affiliated with a second STA and a fourth STA. In such a system, the first STA is configured for generating a management frame comprising a header indicating a second MLD; and sending the generated management frame to the first MLD. In such a system, the first MLD is configured for: receiving, from the first STA, the management frame; encrypting the management frame based on a security association established between the first MLD and the second MLD; and sending the encrypted management frame toward the second MLD via one of the first STA and the third STA.

In some embodiments, the header of the management frame indicates one of: a destination address of the second station and a source address of the first station.

In some embodiments, the header of management frame further indicates a receiver address of the second STA and a transmitter address of the first STA.

In some embodiments, the first MLD is further configured for updating the header of the encrypted management frame to indicate one or more of: a receiver address of the second MLD, a transmitter address of the first MLD.

In some embodiments, the first STA includes a first internal connection to the first MLD, the third STA includes a third internal connection to the first MLD. In such a system receiving, from the first STA, the management frame includes receiving via the first internal connection; and sending the encrypted management frame toward the second MLD via one of the first STA and the third STA comprises transmitting the encrypted management frame using an over the air (OTA) connection.

In some embodiments, the sending step includes sending the encrypted management frame to the first STA via the first internal connection; and sending the encrypted management frame from the first STA to the second STA via the OTA connection, wherein the header of the encrypted management is updated to indicate a receiver address of the second STA and a transmitter address of the first STA.

In some embodiments, the sending step includes sending the encrypted management frame to the third STA via the third internal connection; and sending the encrypted management frame from the third STA to the fourth STA via the OTA connection, wherein the header of the encrypted management is updated to indicate a receiver address of the fourth STA and a transmitter address of the third STA.

Another aspect of the disclosure provides a system of communication between a first multi-link device (MLD) and a second MLD, the first MLD being affiliated with a first station (STA) and a third STA, the second MLD being affiliated with a second STA. In such a system, the first STA is configured for receiving, from the second MLD using an over the air (OTA) connection, an encrypted management frame comprising a header indicating the second MLD; and sending, to the first MLD, the encrypted management frame. In such a system, the first MLD is configured for receiving, from the first STA, the encrypted management frame; decrypting the encrypted management frame based on a security association established between the first MLD and the second MLD; and sending the encrypted management frame based on a header of the decrypted management frame.

In some embodiments, the header of the encrypted management frame indicates one of: a destination address of the first STA, a destination address of the third STA, and a source address of the second STA. In some embodiments, the header of the encrypted management frame further indicates a receiver address of the first MLD and a transmitter address of the second MLD.

In some embodiments, the OTA connection is between the first STA and the second STA, and wherein the first STA includes a first internal connection to the first MLD. In such a system the sending, to the first MLD, the encrypted management frame includes sending the encrypted management frame via the first internal connection; and
the receiving, from the first STA, the encrypted management frame includes receiving the encrypted management frame via the first internal connection.

In some embodiments, the first MLD is further configured for updating, the header of the decrypted management frame to indicate one or more of: a receiver address of one of the first STA and the third STA, a transmitter address of the second STA.

In some embodiments, the receiver address indicates the first STA, the sending the encrypted management frame based on a header of the decrypted management frame includes sending, to the first STA, the decrypted encrypted management frame.

In some embodiments, the receiver address indicates the third STA, the sending the encrypted management frame based on a header of the decrypted management frame includes sending, to the third STA, the decrypted encrypted management frame.

Other aspects of the disclosure provide devices for implementing the methods described herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates an MLD architecture, according to an embodiment of the present disclosure.

FIG. 2 illustrates MLD security association, according to an embodiment of the present disclosure.

FIG. 3 illustrates IEEE 802.11 management frame addressing, according to an embodiment of the present disclosure.

FIG. 4 illustrates 802.11 data frame addressing according to an embodiment of the present disclosure.

FIG. 5 illustrates unicast management frames transmission in MLD context, according to an embodiment of the present disclosure.

FIG. 6 illustrates an enhanced management frame addressing in MLO, according to an embodiment of the present disclosure.

FIG. 7 illustrates a unicast management frame path, according to an embodiment of the present disclosure.

FIG. 8 is a call flow diagram of a link-specific uplink (UL) management frame flow, according to an embodiment of the present disclosure.

FIG. 9 is call flow diagram of a link-specific downlink (DL) management frame flow, according to an embodiment of the present disclosure.

FIG. 10 is a schematic diagram of a user equipment (UE) that may perform any or all of operations of the above methods and features explicitly or implicitly described herein, according to different embodiments of the present invention.

It will be noted that throughout the appended drawings, like features are identified by like reference numerals.

### DETAILED DESCRIPTION

A wireless communications system to which the embodiments of the present disclosure are applicable may be a wireless local area network (WLAN). The communications device may be a wireless communications device that supports parallel transmission on a plurality of links. Such a communication device may be called a multi-link device (MLD) or a multi-band device. MLDs may have higher transmission efficiency and higher throughput than devices that support only single-link transmission.

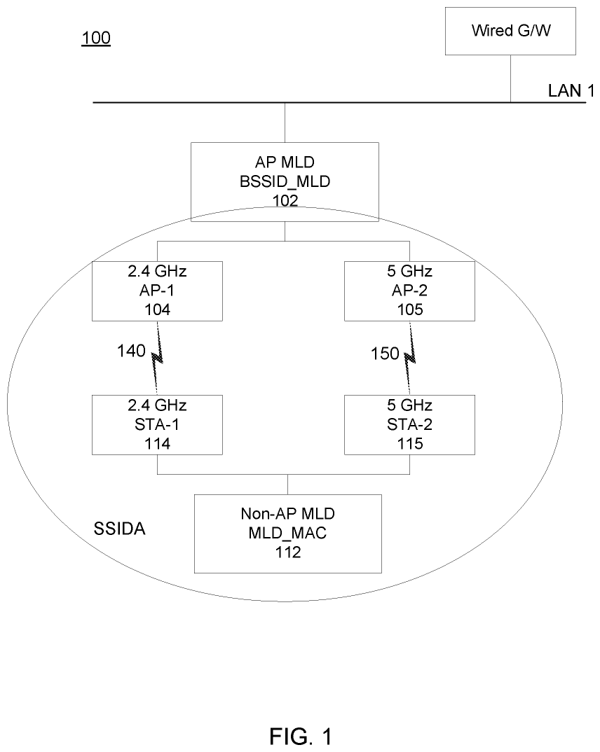

An MLD may be described as a WLAN entity that has multiple radio links to another MLD entity as further described in reference to FIG. 1. An AP MLD may refer to an MLD, where each station (STA) affiliated with the MLD is an AP. A non-AP MLD may be referred to an MLD, where each STA affiliated with the MLD is a non-AP STA. Accordingly, STA may refer to an AP STA or a non-AP STA.

FIG. 1 illustrates an MLD architecture 100, according to an embodiment of the present disclosure. As may be appreciated by a person skilled in the art, an MLD may be a logical entity that may have more than one affiliated STA and a single medium access control (MAC) service access point (SAP) to logical link control (LLC), which may include one MAC data service. Accordingly, an MLD has internal connections, to its affiliated STAs. It should be appreciated that such an internal connection can be wired, Bluetooth, or some other connection that creates the affiliation between the MLD and the affiliated STA.

A typical use case of MLD may be an Access Point (AP) MLD 102 connected to a non-AP MLD (a WLAN terminal) 112 using 2 radio links in the 2.4 GHz (link 140) and 5 GHz (link 150) WLAN bands. The individual radio links 140 and 150 may be referred to as links. Radio units 104, 105 within the AP MLD 102 are referred to as affiliated APs (e.g., 2.4 GHz AP-1 (AP-1 104) and 5 GHz AP-2 (AP-2 105)). Radio units 114, 115 within the Non-AP MLD 112 are referred to as affiliated STAs (e.g., 2.4 GHz STA-1 (STA-1 114) and 5 GHz STA-2 (STA-2 115)).

Each of the affiliated APs 104 and 105 may also serve legacy non-AP STAs. For example, an AP MLD 102 with a 2.4 GHz radio link 140 could also behave as a legacy AP serving a legacy 802.11ax non-AP STA. In this case, the source of the 2.4 GHz radio link is an affiliated AP 104 within the AP MLD 102 as illustrated.

As may be appreciated by a person skilled in the art, the operation of an MLD may be different from that of two logical stations (STAs) (a multiband client) in the same physical entity (e.g., two non-AP STAs in the same handset). Within an MLD, traffic may be coordinated between the two links and the security association is maintained across them. This provides some benefits over the multiple logical STAs concept.

As mentioned, a MLD may include one or more affiliated STAs, as shown in FIG. 1. The AP MLD 102 may be connected to a local area network (LAN), e.g., LAN 1, which may be connected to a wired G/W (Gateway) as illustrated. The AP MLD 102 may have a basic service set (BSS) identifier (ID) of MLD. FIG. 1 illustrates SSIDA as an SSID (Service Set Identifier) that identifies the network. In this case, the AP MLD 102 may provide access to the LAN to non-AP MLDs through the affiliated APs (AP-1 104 and AP-2 105). AP-1 104 and AP-2 105 may also provide access to the LAN for legacy devices. The STAs (e.g., 104, 105, 114 and 115) are logical stations that can each work on one link. The logical stations 104 and 105 which belong to the AP MLD may be access points (APs) and the logical stations 114 and 115 which belong to the non-AP MLD may be non-access point stations (non-AP STAs).

Without the limiting the scope of the disclosure, a multi-link device 102 that belongs to an AP may be referred to as a multi-link AP, a multi-link AP device, or an AP multi-link device (AP multi-link device, AP MLD). Similarly, a multi-link device 112 that belongs to a non-AP STA may be referred to as a multi-link STA, a multi-link STA device, or a STA multi-link device (STA multi-link device, STA MLD). Further, “a member STA” may be referred to as “a STA”, such that “a multi-link device that includes a member STA” may be described as “a multi-link device that includes a STA”.

The MLD 102 or 112 may be a single antenna device or may be a multi-antenna device. For example, a device with more than two antennas may be used. A quantity of antennas included in the multi-link device is not limited in embodiments of the present disclosure. The multi-link device 102 or 112 may allow a service of a same access type to be transmitted on different links, or even allow a same data packet to be transmitted on different links. Alternatively, services of the same access type cannot be transmitted on different links, but services of different access types can be transmitted on different links.

IEEE 802.11 security is established between a STA and an AP to protect traffic exchanged by the two entities. The security framework is an authentication and key management framework that has been built on top of the IEEE 802.1X standard. IEEE 802.1X defines a protocol that allows a Supplicant (which is mapped in an IEEE 802.11 infrastructure network to a non-AP STA) and an Authenticator (which is mapped in an IEEE 802.11 infrastructure network to an AP) to mutually authenticate and establish a security association. In an IEEE 802.11 infrastructure network, the identity of the supplicant may be the MAC address of the STA, and the identity of the Authenticator may be the MAC address of the AP.

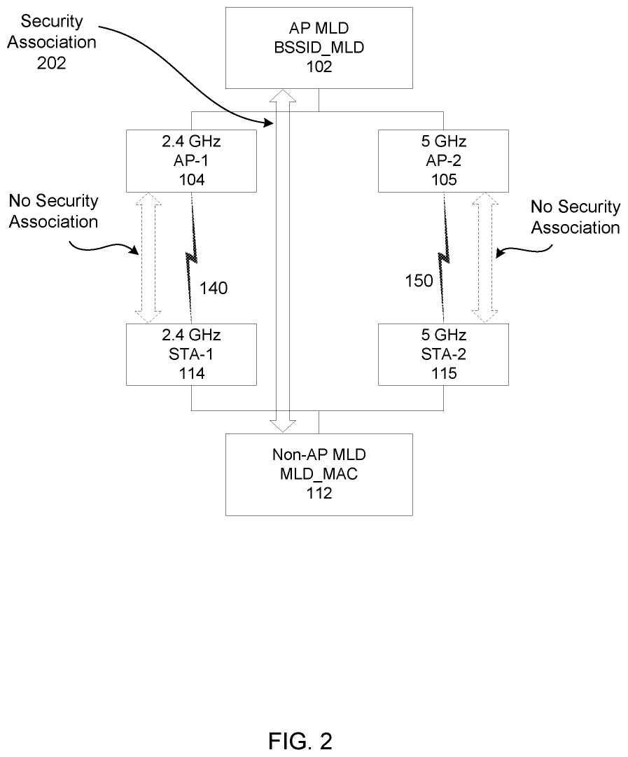

FIG. 2 illustrates MLD security association, according to an embodiment of the present disclosure. FIG. 2 shows that a non-AP MLD 112 may use its non-AP MLD MAC address to associate with an AP MLD 102. The non-AP MLD 112 and the AP MLD 102 may mutually authenticate each other to establish a communications state to exchange data. The MLDs 102 and 112 may communicate over links 140 and 150 between affiliated STAs (link 140 between AP-1 104 and STA-1 114 and Link 150 between AP-2 105 and STA-2 115). When authentication and association protocols complete successfully, the affiliated STAs 114 and 115 of the non-AP MLD 112 may then be associated with the respective affiliated APs 104 and 105 of the AP MLD 102.

When a non-AP MLD 112 associates to an AP MLD 102, the non-AP MLD 112 may establish a security association 202 through the authenticator associated with the AP MLD 102. From an MLD security point of view, the security association 202 is established between the non-AP MLD 112 and AP MLD 102 but there is no security association between the affiliated non-AP STAs (STA-1 114 and STA-2 115) and their respective affiliated APs (2.4 GHz AP-1 104 and 5 GHz AP-2 105). Accordingly, no security association exists between the STA-1 114 and the affiliated AP-1 104, since the communication over link 140 may use the AP MLD security association 202.

As discussed, the MLD concept allows for multiple WLAN connections between an AP MLD 102 and a non-AP MLD 112. Traffic may flow on any of the multiple connections (e.g., link 140 or 150) and may provide a performance gain (due to using multiple channels).

As mentioned, the security association 202 is established between the AP and the non-AP MLD. The links (e.g., 140 and 150), comprising affiliated APs (104 and 105) and affiliated STAs (114 and 115), do not take part in the MLD security association 202. Accordingly, there is no security association between the affiliated APs (104 and 105) and affiliated STAs (114 and 115) when acting as links for the AP MLD and non-AP MLD. Embodiments of the disclosure provide solutions to this problem.

As may be appreciated by a person skilled in the art, 802.11, may involve various types of frames, two of which may include, data frames and management frames. Management frames may be unicasted between an AP and a STA and vice versa. In the base 802.11 standard, unicast management frames may be encrypted with the Pairwise Transient Key Security Association (PTKSA), which may be encrypted with keys that are negotiated between, for example, an AP and STA. However, for multi-link operation (MLO), the PTKSA is established between the non-AP MLD and the AP MLD. Accordingly, for MLO, there may be two possible unicast management frame transmissions: between the AP MLD (e.g., AP MLD 102) and non-AP MLD (e.g., non-AP MLD 112) for general management frames; and between an affiliated AP (e.g., AP-1 104 or AP-2 105) and affiliated STA (e.g., STA-1 114 or STA-2 115) for radio specific management frames (e.g., Radio Resource Management (RRM)).

As may be appreciated by a person skilled in the art, in MLO, the affiliated STAs and APs have the ability to map addresses to the corresponding MLD address, wherein each affiliated AP may have a unique BSSID. For example, AP MLD 102 may send a frame to a non-AP MLD 112, via an affiliated AP (e.g., AP-1 104 or AP-2 105) and an affiliated STA (e.g., STA-1 114 or STA-2 115). The AP MLD 102 may relay the frame to its affiliated AP (e.g., AP-1 104 or AP-2 105), which sends the frame to the affiliated STA (e.g., STA-1 114 or STA-2 115). The affiliated STA (e.g., STA-1 114 or STA-2 115) may then relay the frame to the non-AP MLD 112.

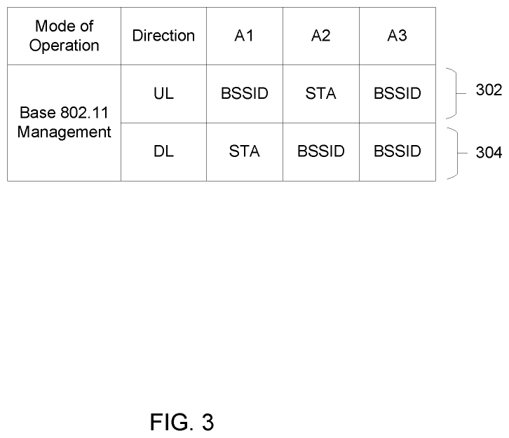

FIG. 3 illustrates IEEE 802.11 management frame addressing, according to an embodiment of the present disclosure. In the base 802.11 standard, when a management frame is exchanged between an AP and a STA, the MAC header may comprise one or more fields including address 1 (A1), address 2 (A2), and address 3 (A3).

For base 802.11 standard operation, a management frame in the UL direction may have A1 set to BSSID, A2 set to STA and A3 set to BSSID as illustrated in row 302. Similarly, a management frame in the DL direction may have A1 set to STA, A2 set to BSSID and A3 set to BSSID as illustrated in row 304.

The base 802.11 standard may refer to the current addressing scheme for 802.11 non-MLDs. Unicast management frames for MLO may be encrypted with the PTKSA, which is established between the non-AP MLD 112 and the AP MLD 102 as discussed.

As may be appreciated by a person skilled in the art, the field requirements for A1, A2 and A3 may depend on the type of frame that is being transmitted. Accordingly, in MLO, A1, A2, and A3 in a frame may change based on the link selected to transmit the frame.

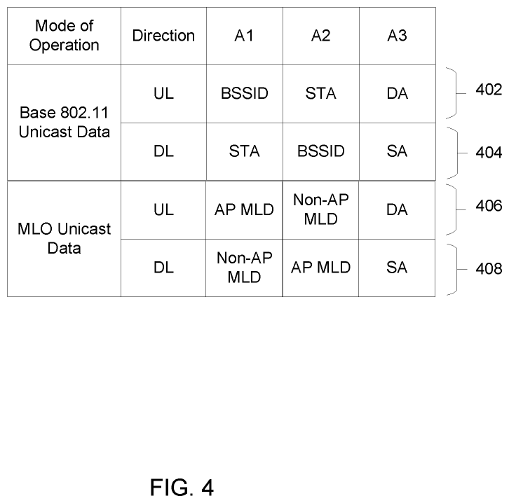

FIG. 4 illustrates 802.11 data frame addressing according to an embodiment of the present disclosure.

For base 802.11 standard operation, in the UL direction, a unicast data frame, before being encrypted, may have A1 set to the receiver address (RA), e.g., BSSID, A2 set to the transmitter address (TA), e.g., STA (that is transmitting the data frame), and A3 set to the destination address (DA) as illustrated in row 402. The DA may be any DA that is accessible over, e.g., the LAN via the STA (that is transmitting the data frame). As may be appreciated by a person skilled in the art, the LAN may be a wireless LAN or a segment of a wired LAN to which the AP is attached.

Similarly, for base 802.11 standard operation in the DL direction, a unicast data frame may have A1 set to STA, A2 set to BSSID, and A3 set to the source address (SA) as illustrated in row 404.

For MLO (e.g., 802.11be) in the UL direction, a unicast data frame may have A1 set to AP MLD, A2 set to non-AP MLD, and A3 set to DA as illustrated in row 406. Similarly, for MLO in the DL direction, a unicast data frame may have A1 set to non-AP MLD, A2 set to AP MLD, and A3 set to SA as illustrated in row 408. As may be appreciated by a person skilled in the art, in the addressing scheme of FIG. 4, the AP MLD address may replace the BSSID for MLO, as illustrated.

As may be appreciated by a person skilled in the art, the addressing indicated by FIG. 4 for base 802.11 operation and MLO operation, is applied before the data frame is encrypted and after the data frame has been decrypted. In MLO, the RA and TA may be replaced after encapsulation with link-specific addresses. And prior to encapsulation, the MLD AP address may replace the B S SID.

However, when a data frame is transmitted over, for example, a wireless medium, the AP MLD address (e.g., in the UL direction) may be replaced by the affiliated AP for the receiver address (RA=A1), and the transmitter address (TA=A2), e.g., the non-AP MLD may be replaced by the affiliated STA address associated with the non-AP MLD. And when the data frame is decrypted, e.g., for processing the data frame, the affiliated AP address for A1 is then replaced by the AP address, and the affiliated STA address for A2 is replaced by the non-AP MLD address.

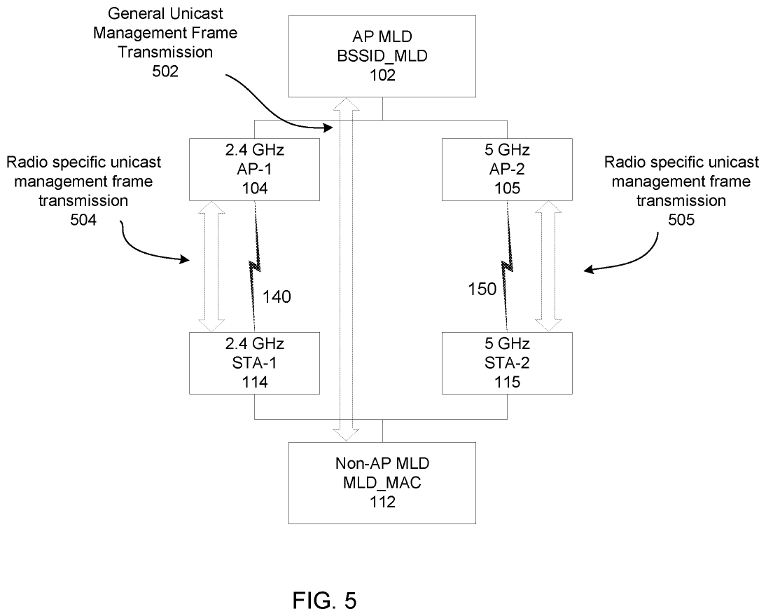

FIG. 5 illustrates unicast management frames transmission in an MLD context, according to an embodiment of the present disclosure. As discussed, for MLO, there may be two possible unicast management frame transmissions: between AP MLD (e.g., AP MLD 102) and non-AP MLD (e.g., non-AP MLD 112) for general management frame transmission 502; and between an affiliated AP (e.g., AP-1 104 or AP-2 105) and affiliated STA (e.g., STA-1 114 or STA-2 115) for radio specific management frames transmission 504 and 505 (e.g., RRM). As may be appreciated by a person skilled in the art, in 802.11be, the Pairwise Transient Key (PTK) is derived using the MLD MAC address and so it is bound to the MLD entity. Therefore, only the MLD is allowed to send the frame encrypted with that PTK.

In the base 802.11 standard, the addressing of unicast management frames may be as follows: A1=DEST_BSSID/STA, A2=SRC_STA/BSSID, A3=BSSID, which is also illustrated in FIG. 3, and where the BSSID is the address of the AP.

In MLO, a legacy AP is split into two logical entities (an affiliated AP and an AP MLD), with security management in the AP MLD as shown in FIG. 2. The AP MLD 102 and non-AP MLD 112 have the option to transmit a frame on either link (e.g., 140 or 150, through their affiliated APs and STAs). This frame may also be a radio specific unicast management frame.

However, since there is no security association between e.g., AP-1 104 and STA-1 114 or AP-2 105 and STA-2 115, a frame originating at, for example, at STA-1 114, may not be encrypted at STA-1 114 for transmission to AP-1 114. Accordingly, the frame may be sent via the security association 202 between AP MLD 102 and non-AP MLD 104.

As a consequence, the addressing of unicast management frames may no longer be correct, as the existing base 802.11 scheme indicates that frames may be directed to the affiliated AP (e.g., AP-1 104 and AP-2 105), which does not manage security and therefore unicast management frames cannot be encrypted or decrypted.

Embodiments may provide for an update to the base 802.11 standard addressing scheme for unicast management frames for Multi-Link Operation (MLO). Embodiments may allow unicast management frames to be forwarded between the affiliated STA and the MLD (e.g., the split logical entities) internally within an MLD. Embodiments may further allow transmission and reception of the frames at the affiliated STA and security encapsulation and decapsulation of the frames at the MLD.

Embodiments may further provide for routing of link-specific unicast management frames (e.g., RRM) by setting the A3 to the affiliated AP/BSSID or the AP MLD. Accordingly, A3 may be leveraged to indicate the specific link that is associated with the management frame.

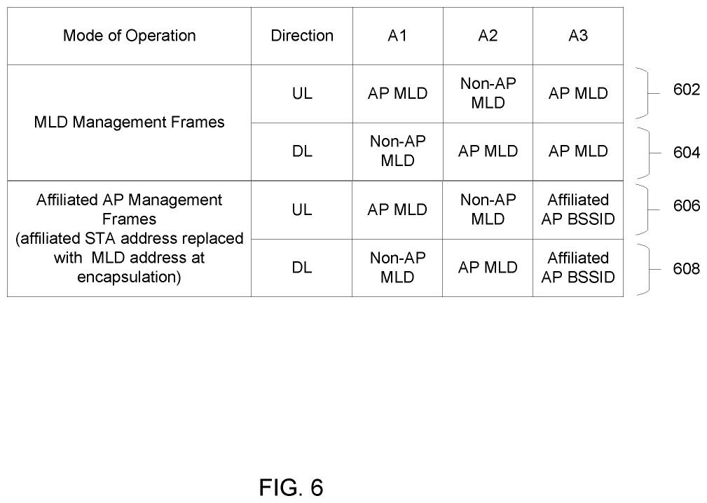

FIG. 6 illustrates an enhanced management frame addressing in MLO, according to an embodiment of the present disclosure. FIG. 6 may provide an enhanced management frame addressing scheme for MLO in IEEE 802.11.

FIG. 6 shows the addressing of MLD management frames transmissions, in UL (row 602) and in DL (row 604), between MLD entities (AP MLD 102 and non-AP MLD 112). Further, affiliated AP management frames, are illustrated, in UL (row 606) and in DL (row 608) between affiliated STA entities (affiliated AP (AP-1 104 and AP-2 105) and affiliated non-AP STA (STA-1 114 and STA-2 115)).

For MLO in the UL direction, row 602, MLD management frames (sent between AP MLD 102 and non-AP MLD 112) may have A1 set to AP MLD, A2 set to non-AP MLD, and A3 set to AP MLD. Similarly, for MLO in the DL direction, row 604, MLD management frames may have A1 set to non-AP MLD, A2 set to AP MLD, and A3 set to AP MLD.

Further, affiliated AP management frames in the UL direction, row 606, before the frame is encapsulated, may have A1 set to AP MLD (the entity that will decrypt the frame), A2 set to non-AP MLD (the STA that is sending the frame), and A3 set to affiliated AP BSSID. As mentioned, A1 may be set to AP MLD, which is the entity that will decrypt the frame. A2 may be set to the non-AP MLD, which is the STA that is sending the frame. A3 may be set to the affiliated AP BSSID, which is the affiliated AP to which the STA is sending the frame to.

In the DL direction, row 608, affiliated AP management frames may have A1 set to non-AP MLD, A2 set to AP MLD, and A3 set to affiliated AP BSSID (which is associated with the affiliated STA that is receiving the frame).

Referring to FIG. 5, for a management frame being sent by STA-1 114 to AP-1 104, A1 may be set to AP MLD, A2 may be the non-AP MLD, and A3 set to AP-1. And similarly, for a frame being sent form AP-1 104 to STA-1 114, A1 may be set to non-AP MLD, A2 may be set to AP MLD, and A3 may be set to AP-1.

In an embodiment, in MLO, STA-1 114 may send a management frame to AP-1. In doing so, STA-1 114 may construct the frame and transfer it to the non-AP MLD 112. The non-AP MLD may encrypt the frame and send it to the AP MLD 102, via the affiliated links, e.g., link 140 or 150. The AP MLD 102 may decapsulate the encrypted frame. The AP MLD 102 may determine that the frame has A1 set to AP MLD and A3 set to AP-1. Accordingly, the AP MLD may send the frame to AP-1.

As may be appreciated by a person skilled in the art, the affiliated AP (e.g., AP-1 104 and AP-2 105) and the affiliated STAs (e.g., STA-1 114 and STA-2 115), maybe involved in the construction and the transmission of the frame as discussed herein.

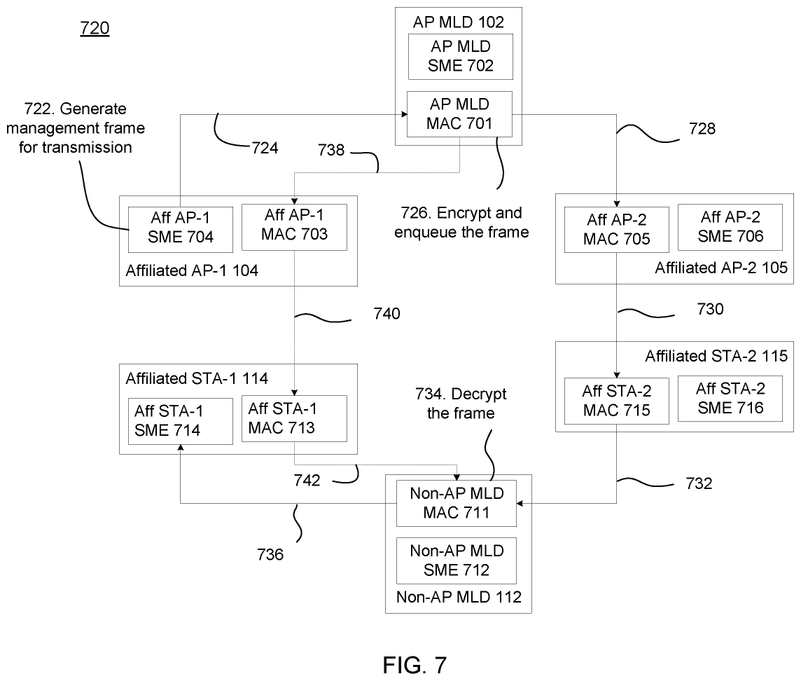

FIG. 7 illustrates a unicast management frame path, according to an embodiment of the present disclosure. Frame path 720 illustrates a unicast management frame path from an affiliated AP-1 104 to affiliated STA-1 114, as illustrated.

Referring to FIG. 7, AP MLD 102 may comprise an AP MLD MAC instance 701 and an AP MLD station management entity (SME) instance 702. The affiliated AP-1 104 may comprise an affiliated AP-1 MAC instance 703 and an affiliated AP-1 SME instance 704. The affiliated AP-2 105 may comprise an affiliated AP-2 MAC instance 705 and an affiliated AP-2 SME instance 706.

Similarly, non-AP MLD 112 may comprise a non-AP MLD MAC instance 711 and a non-AP MLD SME instance 712. The affiliated STA-1 114 may comprise an affiliated STA-1 MAC instance 713 and an affiliated STA-1 SME instance 714. The affiliated STA-2 115 may comprise an affiliated STA-2 MAC instance 715 and an affiliated STA-2 SME instance 716.

As mentioned, the path 720 illustrates the path of a unicast management frame from an affiliated AP-1 SME instance 704 to the affiliated STA-1 SME 714 as illustrated. As may be appreciated by a person skilled in the art, the affiliated AP SME and the affiliated STA SME may transmit management frames between each other.

At 722, the affiliated AP-1 SME instance 704 may generate a unicast management frame (UMF) for transmission to the affiliated STA-1 SME 714. At 724, the affiliated AP-1 SME instance 704 may forward the UMF to the AP MLD MAC instance 701 for encryption of the frame, as MLD security is managed at the AP MLD. The message at 724 may be an internal communication between the affiliated AP-1 SME 704 and the AP MLD MAC instance 701.

At 726, the AP MLD MAC instance 701 may encrypt and enqueue the UMF. The AP MLD MAC instance 701 may set the SA (A3) of the UMF to the affiliated AP-1 SME. As may be appreciated by a person skilled in the art, A3 of the UMF may be set to the BSSID, which in this direction (in DL) may be the SA. The AP MLD MAC instance 701 may then determine an affiliated AP MAC instance (e.g., affiliated AP-2 MAC instance 705) of a set of affiliated AP MAC instances (e.g., affiliated AP-1 MAC instance 703 or affiliated AP-2 MAC instance 705) to send the UMF for transmission to the affiliated STA-1 SME 714.

Accordingly, at 728, the AP MLD MAC instance 701 may transmit the encrypted UMF to an affiliated AP (e.g., affiliated AP-2 MAC 705) for transmission to an affiliated STA (e.g., an affiliated non-AP STA (affiliated STA-1 114 or affiliated STA-2 115).

At 730, the affiliated AP-2 MAC instance 705 may transmit the encrypted UMF to an affiliated STA-2 MAC instance 715 as illustrated. At 732, the affiliated STA-2 MAC instance 715 may forward the encrypted UMF to the non-AP MLD MAC instance 711 for decryption.

At 734, the non-AP MLD MAC instance 711 may decrypt the UMF. The non-AP MLD MAC instance 711 may determine that the UMF is destined to the affiliated STA-1 SME instance 714 based on the A3 of the frame. The A3 may indicate the address of the affiliated AP SME (e.g., affiliated AP-1 SME instance 704), and based on the security association 202 between the AP MLD 102 and the non-AP MLD 112, the non-AP MLD MAC instance 711 may determine that the associated STA SME instance for the affiliated AP-1 SME instance 704 may be the affiliated STA-1 SME instance 714. Accordingly, at 736, the non-AP MLD MAC instance 711 may forward the decrypted UMF to the affiliated STA-1 SME instance 714.

As may be appreciated by a person skilled in the art, the transmission at 730, may occur at any of available links between the AP MLD 102 and the non-AP MLD 112 (e.g., link 140 or link 150). Since the links (e.g., link 140 or 150) communicate frames between the AP MLD 102 and the non-AP MLD 112, either link may be used. Accordingly, in another embodiment, actions performed at 728, 730 and 732 may be replaced with actions performed at 738, 740 and 742 respectively. For example, at 738, the AP MLD MAC instance 701 may transmit the encrypted UMF to an affiliated AP (e.g., affiliated AP-1 MAC instance 703) for transmission to an affiliated STA (e.g., an affiliated non-AP STA (affiliated STA-1 114). At 740, the affiliated AP-1 MAC instance 703 may transmit the encrypted UMF to an affiliated STA-1 MAC instance 713 as illustrated. At 742, the affiliated STA-1 MAC instance 713 may forward the encrypted UMF to the non-AP MLD MAC instance 711 for decryption.

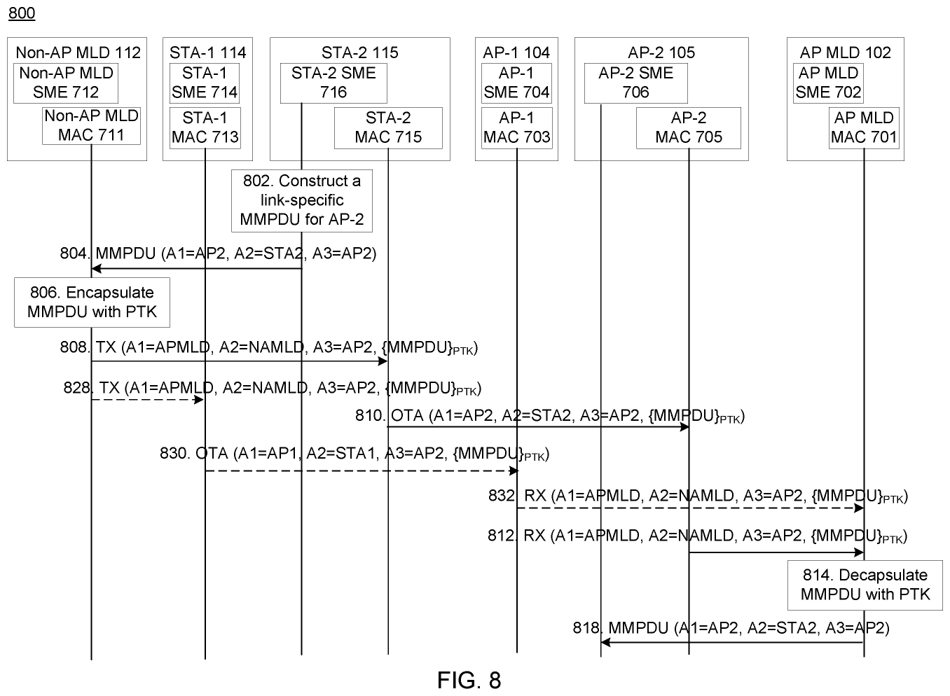

FIG. 8 is a call flow diagram of a link-specific management frame flow, according to an embodiment of the present disclosure. Call flow 800 may illustrate transmission of a UMF from an affiliated STA-2 to an affiliated AP-2 105.

Referring to FIG. 8, at 802, the affiliated STA-2 SME instance 716 may construct a link-specific management MAC protocol data unit (MMPDU) for transmission to an affiliated AP2 (e.g., affiliated AP-2 105). A typical example of a link specific MMPDU may be a Radio Resource Measurement frame).

At 804, the affiliated STA-2 SME instance 716 may send the MMPDU to the non-AP MLD MAC instance 711 using the addressing: A1 set to AP2, A2 set to STA2 and A3 (the DA) set to AP2.

As may be appreciated by a person skilled in the art, the non-AP MLD 112 (e.g., the non-AP MLD MAC instance 711) may determine from the A3 of the MMPDU frame received that the AP-2 is the destination address. Based on the security association 202, the non-AP MLD 112 may determine that the AP-2 is affiliated with the AP MLD 102. Accordingly, the non-AP MLD may send the encapsulated MMPDU to the AP MLD via an affiliated STA MAC instance (e.g., affiliated STA-2 MAC instance 715) selected from a set of STA MAC instances (e.g., in this embodiment, affiliated STA-1 MAC 713 and affiliated STA-2 MAC 715). The non-AP MLD may send the encapsulated MMPDU using any of the affiliated STAs (e.g., STA1 or STA2).

When non-AP MLD 112 associates with the AP MLD 102, their corresponding affiliates are mapped to each other, such that STA-1 may be mapped with AP-1, STA-2 may be mapped with AP-2 and so on. Further, although non-AP MLD 112 and AP MLD 102 are illustrated to have two links (e.g., 140 and 150) via their respective affiliated STAs and affiliated APs, a person skilled in the art may appreciate that more than two links may exist between non-AP MLD 112 and AP MLD 102 (e.g., more than two affiliated Aps may exist for the AP MLD and more than two affiliated STAs may exist for the non-AP MLD).

At 806, the non-AP MLD MAC instance 711 may encapsulate the MMPDU with a PTK (encryption).

In this specification, the term encapsulation implies encryption and forwarding, such that when a frame is encapsulated, the frame is encrypted and forwarded within another frame. It should be appreciated according to a person skilled in the art that in some embodiments, the payload is received and encrypted, inserted into a new frame with new header information, and sent by the forwarding, transmitting, or sending entity.

The non-AP MLD MAC instance 711 may then forward, at 808, the frame to the affiliated STA-2 MAC instance 715 using the addressing: A1 set to AP MLD, A2 set to non-AP MLD and A3 set to AP2. Since the encapsulation is based on the security association 202 between the non-AP MLD 112 and the AP MLD 102, the addressing of the frame is changed, at 808, accordingly.

At 810, the affiliated STA-2 MAC instance 715 may transmit the encrypted MMPDU over the air (OTA) to the affiliated AP-2 105 (e.g., affiliated AP-2 MAC instance 705) using the addressing: A1 set to AP2, A2 set to STA2 and A3 set to AP2. As may be appreciated by a person skilled in the art, the frame transmitted OTA may be enhanced by having its A3 to AP2 (which remains unchanged). In this context, OTA refers to an external wireless interface, for example as defined by IEEE 802.11 as opposed to the internal connections between an MLD and its affiliated stations.

At 812, since the frame is encapsulated based on the security association 202 between the non-AP MLD 112 and the AP MLD 102, embodiments allow the affiliated AP-2 MAC instance 705 to decapsulate and process the received frame. Accordingly, the affiliated AP-2 MAC instance 705 may map the address of the frame, for example, by setting A1 to AP MLD, A2 to non-AP MLD, and maintain A3 as AP2. The affiliated AP-2 MAC instance 705 may then forward the frame with updated addresses to AP MLD 102 (e.g., AP MLD MAC instance 701) for decapsulation.

At 814, the AP MLD 102 (e.g., AP MLD MAC instance 701) may decapsulate the MMPDU with the PTK (decryption). The AP MLD 102 (e.g., AP MLD MAC instance 701) may determine, based on A3 (which is set to AP-2), that the frame is destined to AP-2 105. Further, based on A2 indicating non-AP MLD, the AP MLD 102 (e.g., AP MLD MAC instance 701) may determine that the transmitter address (TA) may be the affiliated STA (e.g., STA-2 115) that is mapped to AP-2 105. Accordingly, the AP MLD 102 (e.g., AP MLD MAC instance 701) may then send the decapsulated frame to the AP-2 105 using the addressing: A1 set to AP2, A2 set to STA2, and A3 set to AP2. As may be appreciated by a person skilled in the art, the addressing of the decapsulated frame sent by AP MLD 102 (e.g., AP MLD MAC instance 701) may be similar to the addressing of the MMPDU header 804 sent by the affiliated STA2 SME to the non-AP MLD as illustrated.

In another embodiment, actions performed at 808, 810 and 812 may be alternatively performed by actions at 828, 830 and 832 respectively as illustrated. As mentioned, when the non-AP MLD MAC instance 711 encrypts the MMPDU with the PTK at 806, the non-AP MLD MAC instance 711 may send, at 828, the encapsulated MMPDU to the AP MLD via an affiliated STA MAC instance (e.g., affiliated STA-1 MAC instance 713) selected from a set of STA MAC instances (e.g., in this embodiment, affiliated STA-1 MAC 713 and affiliated STA-2 MAC 715). The non-AP MLD MAC instance 711 may forward the frame to the affiliated STA-1 MAC instance 713 using the addressing: A1 set to AP MLD, A2 set to non-AP MLD and A3 set to AP2.

At 830, the affiliated STA-1 MAC instance 713 may transmit the encrypted MMPDU over the air (OTA) to the affiliated AP-1 104 (e.g., affiliated AP-1 MAC instance 703) using the addressing: A1 set to AP1, A2 set to STA1 and A3 set to AP2. As may be appreciated by a person skilled in the art, the frame transmitted OTA may be enhanced by having its A3 to AP2 (which remains unchanged).

At 832, since the frame is encapsulated based on the security association 202 between the non-AP MLD 112 and the AP MLD 102, the affiliated AP-1 MAC instance 703 may be unable to decapsulate and process the received frame. Accordingly, the affiliated AP-1 MAC instance 703 may map the address of the frame, for example, by setting A1 to AP MLD, A2 to non-AP MLD, and maintain A3 as AP2. The affiliated AP-1 MAC instance 703 may then forward the frame with updated addresses to AP MLD 102 (e.g., AP MLD MAC instance 701 for decapsulation.

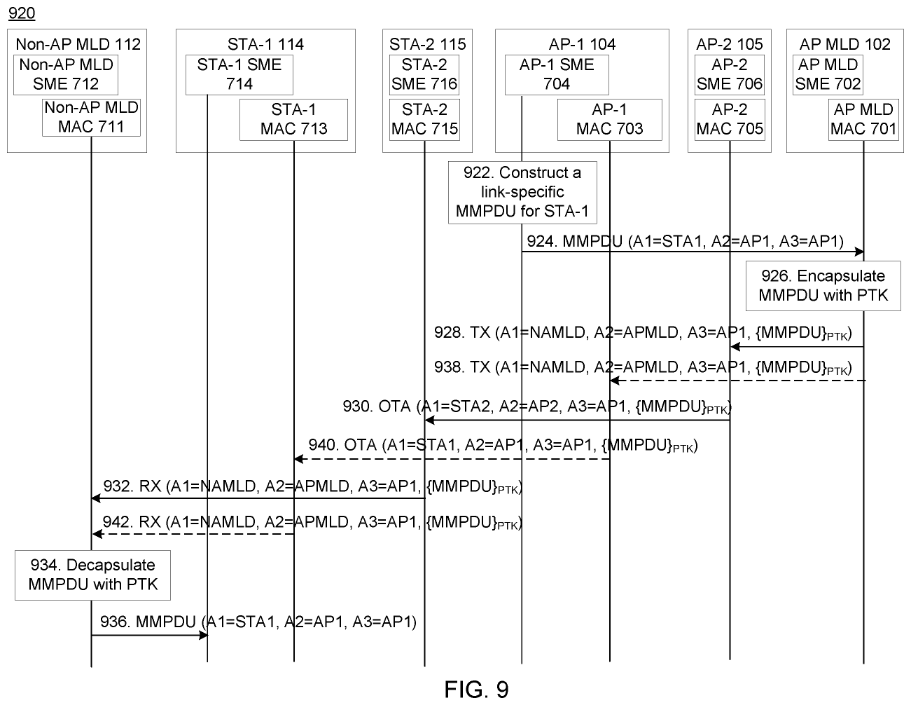

FIG. 9 is call flow diagram of a link-specific management frame flow in DL, according to another embodiment of the present disclosure. Call flow of FIG. 9 may reflect the unicast management frame path of FIG. 7 as further described herein.

Referring to FIG. 9, Call flow 920 may reflect frame path 720 of FIG. 7, illustrating a unicast management frame path from an affiliated AP-1 104 to the affiliated STA-1 114, as illustrated. At 922, which may be similar to 722, the affiliated AP-1 SME instance 704 may construct a link-specific management MAC protocol data unit (MMPDU) for transmission to the affiliated STA-1 114 (STA-1 SME 714).

At 924, which may be similar to 724, the affiliated AP-1 SME instance 704 may forward the MMPDU to the AP MLD MAC instance 701 for encryption of the frame, as MLD security is managed at the AP MLD. In forwarding the MMPDU, the affiliated AP-1 SME instance 704 may use the addressing: A1 set to STA1, A2 set to AP1 and A3 set to AP1. The message at 924 may be an internal communication between the affiliated AP-1 SME 704 and the AP MLD MAC instance 701.

As may be appreciated by a person skilled in the art, the AP MLD 102 (e.g., the AP MLD MAC instance 701) may determine from the A1 of the MMPDU frame received that STA-1 114 is the receiver address. Based on the security association 202, the AP MLD 102 may determine that STA-1 is affiliated with the non-AP MLD 112. The AP MLD MAC instance 701 may then determine an affiliated AP MAC instance (e.g., affiliated AP-2 MAC instance 705) of a set of affiliated AP MAC instances (e.g., affiliated AP-1 MAC instance 703 or affiliated AP-2 MAC instance 705) to send the MMPDU for transmission to the affiliated STA-1 SME 714. The AP MLD 102 may encrypt and send MMPDU to the non-AP MLD via an affiliated AP MAC instance (e.g., affiliated AP-2 MAC instance 705).

Accordingly, at 926, which may be similar to 726, the AP MLD MAC instance 701 may the MMPDU with a PTK (encryption). The AP MLD MAC instance 701 may then forward, at 928 (similar to 728), the encapsulated frame to the affiliated AP-2 MAC instance 705 using addressing: A1 set to non-APMLD, A2 set to AP MLD and A3 (SA) set to AP1. Since the encapsulation is based on the security association 202 between the non-AP MLD 112 and the AP MLD 102, the addressing of the frame is changed, at 928, accordingly.

At 930, which may be similar to 730, the affiliated AP-2 MAC instance 705 may transmit the encrypted MMPDU over the air to the affiliated STA-2 MAC instance 715 using the addressing: A1 set to STA2, A2 set to A2 and A3 set to AP1.

At 932, which may be similar to 732, since the frame is encapsulated based on the security association 202 between the non-AP MLD 112 and the AP MLD 102, the affiliated STA-2 MAC instance 715 may be unable to decapsulate and process the received frame. Accordingly, the affiliated STA-2 MAC instance 715 may forward the encapsulated MMPDU to the non-AP MLD MAC instance 711 for decapsulation. In forwarding the encapsulated MMPDU, the affiliated STA-2 MAC instance 715 may use the addressing: A1 set to non-AP MLD, A2 set to AP MLD and A3 set to AP1.

At 934, which may be similar to 734, the non-AP MLD MAC instance 711 may decapsulate the MMPDU with the PTK (decryption). The non-AP MLD MAC instance 711 may determine that the MMPDU is destined to the affiliated STA-1 SME instance 714 based on the A3 of the frame. The A3 may indicate the address of the affiliated AP SME (e.g., affiliated AP-1 SME instance 704), and based on the security association 202 between the AP MLD 102 and the non-AP MLD 112, the non-AP MLD MAC instance 711 may determine that the associated STA SME instance for the affiliated AP-1 SME instance 704 may be the affiliated STA-1 SME instance 714. Accordingly, at 936 (which may be similar to 736) the non-AP MLD MAC instance 711 may forward the decapsulated MMPDU to the affiliated STA-1 SME instance 714 using the addressing A1 set to STA1, A2 set to AP1 and A3 set to AP1.

As may be appreciated by a person skilled in the art, actions performed 930 may occur at any of available links between the AP MLD 102 and the non-AP MLD 112 (e.g., link 140 or link 150). Since the links (e.g., link 140 or 150) communicate frames between the AP MLD 102 and the non-AP MLD 112, either link may be used. Accordingly, in another embodiment, actions performed at 928, 930 and 932 may be replaced with actions performed at 938, 940 and 942 respectively.

Accordingly, in another embodiment, at 938, which may be similar to 738, the AP MLD MAC instance 701 may transmit the encapsulated MMPDU to an affiliated AP (e.g., affiliated AP-1 MAC instance 703) for transmission using addressing: A1 set to AP MLD, A2 set to AP1 and A3 set to A1.

At 940, which may be similar to 740, the affiliated AP-1 MAC instance 703 may transmit, over the air, the encrypted MMPDU to the affiliated STA-1 MAC instance 713 using the addressing: A1 set to STA1, A2 set to AP1 and A3 set to AP1, as illustrated.

At 942, which may be similar to 742, since the frame is encapsulated based on the security association 202 between the non-AP MLD 112 and the AP MLD 102, the affiliated STA-1 MAC instance 713 may be unable to decapsulate and process the received frame. Accordingly, the affiliated STA-1 MAC instance 713 may forward the encapsulated MMPDU to the non-AP MLD MAC instance 711 for decapsulation.

As described herein, embodiments may provide for transmission of management frames based on changing of MAC address. As discussed, for example in reference to FIG. 7 and FIG. 9, management frames may be sent between an AP affiliated with an AP MLD and a STA affiliated with a non-AP MLD via a method. The method may include generating a management frame at an affiliated AP SME with A1 (RA) set STA-1, A2 (TA) set to AP-1, and A3 set to AP-1. It should be appreciated that A3 may be the SA in the case of DL and the DA in the case of UL. The method may further include encapsulating the management frame and changing A1 to non-AP MLD and A2 to AP MLD while keeping A3 the same (e.g., AP-1). The method may further include changing A1 to the affiliated STA and A2 to the affiliated AP on the link that the frame is transmitted over the air. The method may further include receiving the frame at the affiliated STA and changing the A1 to the non-AP MLD and A2 to the AP MLD while leaving A3 the same. The method may further include encapsulating the frame and determining that the frame is destined for STA-1 based on A1, A2, A3 settings. The method may further include receiving the frame at the STA-1 SME from the non-AP MLD.

Embodiments may provide for supporting unicast management frame security within an 802.11 MLD. As described herein, embodiments may further provide an enhanced 802.11 frame addressing scheme, so that unicast management frames may be correctly received, transmitted, encoded (encrypted or encapsulated) and decoded (decrypted or decapsulated) within an MLD. As may be appreciated by a person skilled in the art that the frame addressing scheme may differs depending on whether the unicast management frame is link specific (between an affiliated AP and an affiliated non-AP STA) or general (between a non-AP MLD and an AP MLD).

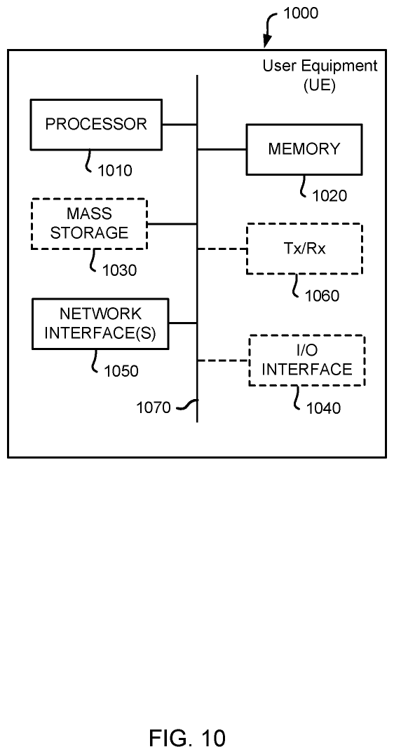

FIG. 10 is a schematic diagram of UE 1000 that may perform any or all of operations of the above methods and features explicitly or implicitly described herein, according to different embodiments of the present invention. For example, a computer equipped with network function may be configured as UE 1000.

As shown, the UE 1000 may include a processor 1010, such as a Central Processing Unit (CPU) or specialized processors such as a Graphics Processing Unit (GPU) or other such processor unit, memory 1020, non-transitory mass storage 1030, input-output interface 1040, network interface 1050, and a transceiver 1060, all of which are communicatively coupled via bi-directional bus 1070. According to certain embodiments, any or all of the depicted elements may be utilized, or only a subset of the elements. Further, UE 1000 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1020 may include any type of non-transitory memory such as static random access memory (SRAM), dynamic random access memory (DRAM), synchronous DRAM (SDRAM), read-only memory (ROM), any combination of such, or the like. The mass storage element 1030 may include any type of non-transitory storage device, such as a solid state drive, hard disk drive, a magnetic disk drive, an optical disk drive, USB drive, or any computer program product configured to store data and machine executable program code. According to certain embodiments, the memory 1020 or mass storage 1030 may have recorded thereon statements and instructions executable by the processor 1010 for performing any of the aforementioned method operations described above.

Embodiments of the present invention can be implemented using electronics hardware, software, or a combination thereof. In some embodiments, the invention is implemented by one or multiple computer processors executing program instructions stored in memory. In some embodiments, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method of communication between a first multi-link device (MLD) and a second MLD, the first MLD being affiliated with a first station (STA) and a third STA, the second MLD being affiliated with a second STA and a fourth STA, the method comprising:
receiving, by the first multi-link device (MLD) from the first station (STA), a management frame comprising a header indicating address information associated with the second MLD;
encrypting, by the first MLD, the management frame based on a security association established between the first MLD and the second MLD; and
sending, by the first MLD, the encrypted management frame toward the second MLD via one of the first STA and the third STA.

2. The method of claim 1, wherein the header of the management frame indicates one of: a destination address of the second station and a source address of the first station.

3. The method of claim 1, wherein the header of management frame further indicates a receiver address of the second STA and a transmitter address of the first STA.

4. The method of claim 1, further comprising:
updating, by the first MLD, a header of the encrypted management frame to indicate one or more of: a receiver address of the second MLD and a transmitter address of the first MLD.

5. The method of claim 1, wherein the first MLD has a medium access control (MAC) instance of the first MLD.

6. The method of claim 1, wherein the first STA has a station management entity (SME) instance of the first STA.

7. The method of claim 1, wherein the third STA has a MAC instance of the third STA.

8. The method of claim 1, wherein the first STA includes a first internal connection to the first MLD, the third STA includes a third internal connection to the first MLD, and wherein:
the receiving step comprises receiving via the first internal connection; and
the sending step comprises transmitting the encrypted management frame using an over the air (OTA) connection.

9. The method of claim 8 wherein the sending step comprises:
sending the encrypted management frame to the first STA via the first internal connection; and
sending the encrypted management frame from the first STA to the second STA via the OTA connection, wherein the header of the encrypted management is updated to indicate a receiver address of the second STA and a transmitter address of the first STA.

10. The method of claim 8 wherein the sending step comprises:
sending the encrypted management frame to the third STA via the third internal connection; and
sending the encrypted management frame from the third STA to the fourth STA via the OTA connection, wherein the header of the encrypted management frame is updated to indicate a receiver address of the fourth STA and a transmitter address of the third STA.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. A system of communication between a first multi-link device (MLD) and a second MLD, the first MLD being affiliated with a first station (STA) and a third STA, the second MLD being affiliated with a second STA and a fourth STA, wherein:
the first STA is configured for:
generating a management frame comprising a header indicating a second MLD; and
sending the generated management frame to the first MLD;
the first MLD is configured for:
receiving, from the first STA, the management frame;
encrypting the management frame based on a security association established between the first MLD and the second MLD; and
sending the encrypted management frame toward the second MLD via one of the first STA and the third STA.

24. The system of claim 23, wherein the header of the management frame indicates one of: a destination address of the second station and a source address of the first station.

25. The method of claim 23, wherein the header of the management frame further indicates a receiver address of the second STA and a transmitter address of the first STA.

26. The system of claim 23, wherein the first MLD is further configured for:
updating the header of the encrypted management frame to indicate one or more of: a receiver address of the second MLD, or a transmitter address of the first MLD.

27. The system of claim 23, wherein the first STA includes a first internal connection to the first MLD, the third STA includes a third internal connection to the first MLD, and wherein:
receiving, from the first STA, the management frame comprises receiving via the first internal connection; and
sending the encrypted management frame toward the second MLD via one of the first STA and the third STA comprises transmitting the encrypted management frame using an over the air (OTA) connection.

28. The system of claim 27, wherein the sending step comprises:
sending the encrypted management frame to the first STA via the first internal connection; and
sending the encrypted management frame from the first STA to the second STA via the OTA connection, wherein the header of the encrypted management is updated to indicate a receiver address of the second STA and a transmitter address of the first STA.

29. The system of claim 27, wherein the sending step comprises:
sending the encrypted management frame to the third STA via the third internal connection; and
sending the encrypted management frame from the third STA to the fourth STA via the OTA connection, wherein the header of the encrypted management is updated to indicate a receiver address of the fourth STA and a transmitter address of the third STA.

30. (canceled)

31. (canceled)

32. (canceled)

33. (canceled)

34. (canceled)

35. (canceled)

36. (canceled)
